(19) United States
(12) Patent Application Publication
(10) Pub. No.: US 2015/0180911 A1
(43) Pub. Date: Jun. 25, 2015

(54) FEEDBACK CHANNEL FOR FEEDBACK FROM SOFTWARE

(71) Applicants: Prasanna Bhat Mavinakuli, Walldorf (DE); Purva Singh, Walldorf (DE); Tejram Jagannath Sonwane, Walldorf (DE); Vaidehi Vaidehi, Walldorf (DE)

(72) Inventors: Prasanna Bhat Mavinakuli, Walldorf (DE); Purva Singh, Walldorf (DE); Tejram Jagannath Sonwane, Walldorf (DE); Vaidehi Vaidehi, Walldorf (DE)

(21) Appl. No.: 14/134,711

(22) Filed: Dec. 19, 2013

(51) Int. Cl. H04L 29/06; G06F 17/22

(52) U.S. Cl. CPC H04L 65/403; G06F 17/2247

(57) ABSTRACT

Embodiments of the present disclosure involve computerized feedback systems and methods. The system includes a user interface configured to receive feedback information using a feedback framework. A feedback server is configured to receive the feedback information and transport the feedback information to a database. The feedback server may provide a pluggable architecture and may be configured to operate in real time, or near real time.

### BACKGROUND OF THE INVENTION

Enterprise systems and software solve different customer situations, problems, and use cases. Traditionally, the user of the system provides their feedback (e.g., problems and requirements) to the software development company during pre-sales presentation at customer events or offline through an email or social network platform. Users may have to call support people and answer several questions to provide feedback.

### SUMMARY OF THE INVENTION

Referring generally to the figures, systems and methods are provided for allowing users to provide feedback in a simple manner. The system provides a mechanism for users to submit feedback information quickly and in near real time. The feedback information in the proposed solution is accessibly stored, for example, in a cloud-based database system. Such a solution also helps the organization get the trend of customer feedback and issues in different products.

One embodiment of the present disclosure relates to a feedback system and methods which enables a user of all software developed to provide information including feedback, error information, new use cases, or requirements in near real time. The system and methods help organizations also by having a near real time application, such as a HANA application, analyze and project future software experiences. Some advantages of the disclosed embodiments include the ability to provide feedback software that can receive feedback from any technological platform and transfer the information to a feedback server and/or database. This allows users to provide real time inputs and communicate issues or feedback without any additional steps. For example, users may attach an image of the screen and provide additional comments using annotation tools.

One embodiment of the present disclosure relates to a system for receiving feedback information in real time and storing the feedback information for access in real time. This system includes a user computing device having a processing circuit configured to receive feedback information from a plurality of users, wherein the user computing device also includes a user display interface configured to display feedback information. The system also includes a feedback architecture configured to enable feedback information to be provided in near real time and a client server configured to receive the feedback information from the user computing device. The client server is configured to operate in real time. The system also includes a client application configured to receive and process the feedback information, the client application being configured to operate in real time, and a non-transitory computer-readable storage unit, which stores the feedback information and provides access to the feedback information.

Another embodiment of the present disclosure relates to a computerized method of providing real-time feedback. This method involves transferring, by a computer system, feedback information entered into a user interface of a user computer system to a client feedback server and using a client server application to manage feedback information action requests wherein the client server application receives feedback information and continuously updates the feedback information in real time. The method also involves transporting the feedback information to modules within the client server, client application, and a non-transitory computer readable storage unit and storing the feedback information in the non-transitory computer readable storage unit.

Another embodiment of the present disclosure relates to a computerized method of receiving feedback information in real time and storing for access in real time. The method involves receiving feedback information entered into a user computing device having a processing circuit configured to receive feedback information from a plurality of users. The user computing device of this method also includes a user display interface configured to display feedback information and a feedback architecture configured to enable feedback information to be provided in real time. The method also includes processing the feedback information using a client application executed by a client server, wherein both the client server and the client application are configured to operate in real time. The method involves transferring the feedback information to a non-transitory computer-readable storage unit, which stores the feedback information and provides access to the feedback information in real time.

Another embodiment of the present disclosure relates to the method described above, further implementing additional steps to implement back office capabilities. Further steps involve enabling manipulation of feedback information displayed on a client computing system to request a function for the feedback information, and accessing, by way of the client server application, the non-transitory computer readable storage unit, wherein the client server application receives a requested function from a client computer system and performs the function as requested. Further steps may also include returning the requested feedback information to the client computer system and performing request functions.

Another embodiment of the present disclosure relates to a computerized method of receiving feedback in real time. This method may include receiving feedback information entered into a user interface on a user computing system and providing a uniform resource identifier to post the feedback information to a client server. The method may also include transferring the feedback information from the user computing system to the client server by way of the uniform resource identifier, wherein the client server is continually updating the feedback information in real time. Additionally, the method could include dispatching feedback from the client server to a non-transitory computer readable storage unit using a client server application, wherein the non-transitory computer readable storage unit is located on a cloud or network of servers and continuously runs to keep feedback information updated in real time, and updating feedback information in the client server application and non-transitory computer readable storage continuously to allow real time access to feedback information.

Another embodiment of the present disclosure is a computerized method of retrieving feedback information submitted in real time including inputting an action request into the client computing device wherein the action request specifies parameters to perform an action involving feedback information. Also, the method includes transferring, by way of the client computing device, the action request for feedback information to the client server which executes a client application in processing the action request. The client server allows access to a non-transitory computer readable storage unit storing feedback received in real time, and the client server and client application are continuously updated to operate in real time. Also, the method includes receiving feedback information retrieved from the non-transitory computer readable storage unit and processed by a client application in real time, the feedback information being displayable on a user computing device.

The embodiments of the present disclosure provide several benefits. Some embodiments allow business personnel to timely provide feedback and suggestions to the software producer by eliminating the need to wait to contact support assistance. Embodiments may allow easy access to the software producer and a uniform way of providing feedback or suggestions across all products. Also, embodiments may provide easy integration into a feedback system for feedback comparison. The embodiments described also allow users to share screen shots and make special requests for features while, if desired, annotating the screen and blocking out certain parts of the screen. The user can also provide feedback by recording through the camera and microphone available, for example, in their desktop, laptop, or mobile computing device. From the organization perspective, the embodiments of the present disclosure provide the back office application servers, for example HANA, so that an administrator or organization can get into the feedback or issues reported in near real time.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims in which:

FIG. 1 is a block diagram of the system used for receiving feedback on a broad scale according to an exemplary embodiment.

FIG. 2A is a block diagram of a system for receiving feedback information including a user computing device, client computing device, feedback server, and database according to an exemplary embodiment.

FIG. 2B is a block diagram of the system showing the feedback server and database in communication on a shared network according to an exemplary embodiment.

FIG. 2C is a detailed block diagram of a system for receiving feedback information in near real time including a user computing device, client computing device, feedback server, and database according to an exemplary embodiment.

FIG. 2D is a detailed block diagram of a client computing device used in retrieving and accessing feedback information in near real time according to an exemplary embodiment.

FIG. 2E is a detailed block diagram of a feedback service used in the system described above according to an exemplary embodiment.

FIG. 3 is a detailed block diagram of feedback information being submitted into the system according to an exemplary embodiment.

FIG. 4 is a detailed view of the feedback panel according to an exemplary embodiment.

FIG. 5 is a detailed flow chart and block diagram of the process of receiving feedback information from the front end according to an exemplary embodiment.

FIG. 6 is a detailed flow chart and block diagram of the process of receiving feedback information from the back end according to an exemplary embodiment.

FIG. 7 is a flow chart of a process for receiving feedback information in real time and storing for access in real time according to an exemplary embodiment.

FIG. 8 is a flow chart of a process of using the feedback system for back office purposes according to an exemplary embodiment.

FIG. 9A is a schematic view of a code sample of the feedback plugin of the system according to an exemplary embodiment.

FIG. 9B is a schematic view of a code sample at the back end of the system according to an exemplary embodiment.

FIG. 9C is a pictorial view of the feedback panel on a user display interface showing an image being sent for feedback according to an exemplary embodiment.

FIG. 9D is a pictorial view of the user display interface information entry page following the submission of information according to an exemplary embodiment.

FIG. 9E is a schematic view of a code sample showing how an image and/or snapshot can be taken according to an exemplary embodiment.

FIG. 9F is a schematic view of a code sample showing how an image and/or snapshot of a system can be passed to a client according to an exemplary embodiment.

FIG. 9G is a pictorial view of a screen image including annotations according to an exemplary embodiment.

FIG. 9H is a pictorial view of a screen image with annotations including blocking of information for view according to an exemplary embodiment.

FIG. 9I is a schematic view of a code sample used to allow annotation on the figures according to an exemplary embodiment.

FIG. 9J is a schematic view of a code sample used to implement non-static information in the system and methods according to an exemplary embodiment.

FIG. 10A is a sequence diagram of launching the feedback information on the feedback server according to an exemplary embodiment.

FIG. 10B is a sequence diagram of posting the feedback information to a back end feed service according to an exemplary embodiment.

FIG. 11 is a high level design view of the system according to an exemplary embodiment.

FIG. 12 is a detailed view of components in the system according to an exemplary embodiment.

### DETAILED DESCRIPTION

Before turning to the figures, which illustrate exemplary embodiments in detail, it should be understood that the application is not limited to the details or methodology set forth in the description or illustrated in the figures. It should also be understood that the terminology is for the purpose of description only and should not be regarded as limiting.

An embodiment of the present disclosure is an application that is easily pluggable to other software applications via a URL that allows users of a software application to quickly submit feedback as configured by the client application. The software then transfers the feedback into a Hana database stored on the cloud, the internet or a network of servers, and provides a tool for the user behind the application to access the feedback reported in real time. This process/application allows a user to provide feedback about the software application quickly and in near real time and also allows personnel behind the software application to access the feedback immediately to analyze the data. This ability is invaluable in providing a way for interested parties to pinpoint, diagnose, and resolve any issues that one may be experiencing with a software application. A back end user is also enabled to employ the application to perform different activities with the information received from the storage or database. Activities could include monitoring activities and data manipulation activities including cut, copy, insert, delete, tally, search, select, update and execute.

Additional embodiments of the disclosure provides for quick access for the user to provide feedback. This benefits the client application in that if feedback can be easily given, there will be a greater likelihood that a user will actually submit feedback. The feedback is made easily accessible by presenting the channel in which to submit feedback in multiple rooms through the user interface. In one embodiment, the channel could be presented in the form of an icon. Upon clicking the icon, a space which accepts feedback is displayed. The more feedback data a client receives, the better quality analysis a client, for example a company, will be able to perform.

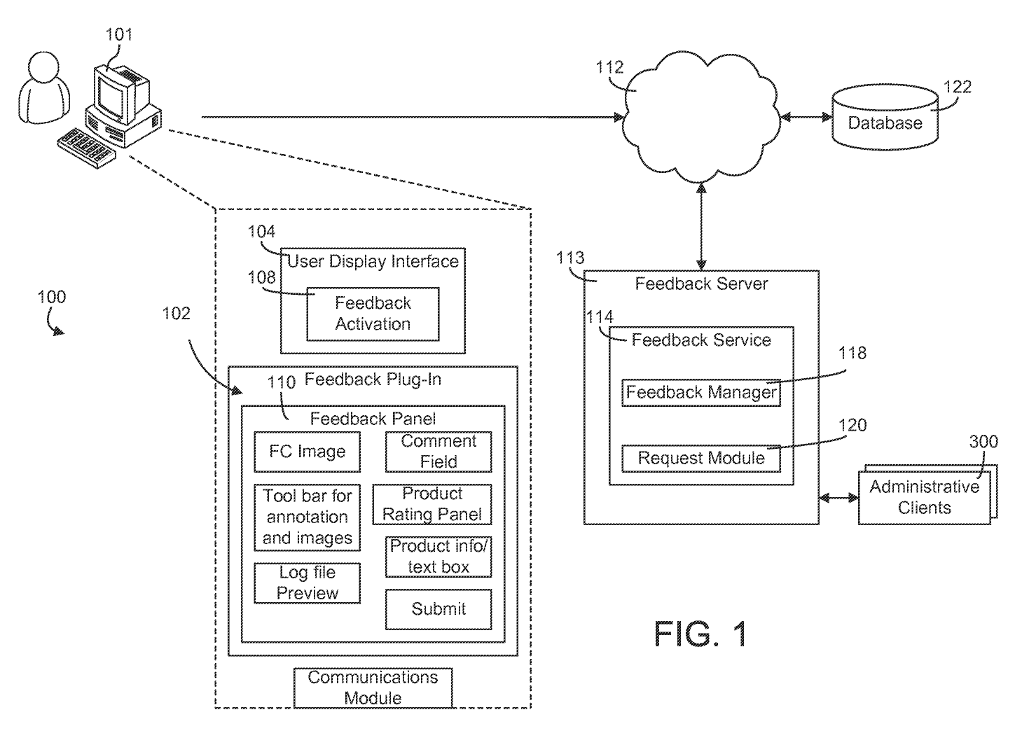

Referring to FIG. 1, an exemplary embodiment shows a block diagram of a feedback system 100 used for receiving feedback. A user is inspired or prompted to pass feedback information to the operators or owners of a software application from a user computing device 101. The feedback information may convey feedback, suggestions, emotions, or any category of information as understood by a person having ordinary skill in the art. The type of feedback information that may be submitted can include text, graphics, images, voice, or video. Some solutions of submitting these types of feedback information are discussed in further detail below.

The feedback information may be submitted through a user display interface 104 on a user computing device 101. While FIG. 1 shows the user display interface 104 on a user computer device 101 of the desktop variety, the user interface 104 may be on any type of computing, mobile, or viewing device, including but not limited to a laptop computer, a tablet or notebook, an interactive television, or a mobile phone device. The feedback information is then transferred to a network 112 which connects to a feedback server 113, wherein the feedback server 113 is continuously updated to run in real time. The feedback information is then transferred to a non-transitory computer readable storage unit (database) 122 which is continuously updated to be reachable and accessible in near real time.

The feedback system 100 overall serves to allow feedback information to be submitted in real time and to allow a client to access and solicit the feedback information from a user at least as soon as the feedback information is submitted. The feedback system 100 also allows very detailed and specific information to be retrieved from the database 122, wherein the information may be used for any type of analysis, metrics, or for viewing. Data and feedback manipulation and analytics that the system, including the feedback service 114, can support includes: getting a list of data, getting details behind the data, and listing aspects such as a title and detailed summary. Analytics that may be performed include but are not limited to numerical calculations, metric evaluation, and a summary or analysis of the feedback such as mean, average, standard deviation, percentages, comparison, likelihood, and cost projections.

FIG. 1 also shows more detailed components of the feedback system 100. Under the first graphic of a user submitting feedback information through a user computing device 101, the diagram displays a feedback plugin 102. The feedback plugin 102 serves to integrate the user computing device 101 with the feedback server 113 and/or feedback service 114, thus allowing feedback information to be submitted from any technological platform. Different technological platforms may include, but are not limited to, computing platforms, for example hardware, operating systems, infrastructure software, or application software. The feedback plugin 102 allows feedback information to be received from all products through a user computing system 101 and transferred from a user computing system 101 without significant effort. In one embodiment, a uniform resource locator (URL) is used for as part of the feedback plugin 102 architecture. The feedback plugin 102 could be any uniform resource identifier, including a uniform resource name.

In one embodiment, a customer uses the system and methods for needs of a product of the customer's, a user uses the customer's product, and that user wishes to provide feedback information to the customer about the customer's product through the system and methods disclosed. A customer of the product may set the parameters of feedback panel 110 including which feedback should be captured by the user. Once the customer sets the parameters, the system may be implemented to receive the feedback according to the parameters set by the customer.

As shown in FIG. 1 and FIG. 4, the user display interface 104 may contain a feed panel 110 that shows the parameters the customer has decided to solicit from a user. These parameters may include fields 202-216 that can convey useful information to a customer, including but not limited to a feed channel (fc) image 202, a tool bar for annotation and image 204 (any field may be annotated using the tool bar), a comment field 210, a product rating panel 212, a product info/text box 214 for product information, a log file preview field 208, and/or a submit button 216. A device or field may also be available to receive voice and video recordings. Although the figures show a submit button 216, the system 100 may be configured to submit feedback information entered into the feedback panel 110 automatically or in some pre-determined time interval. Upon the feedback information being submitted, the system 100 can handle other tasks including, for example, maintaining the feedback information such that the information non-statically update in the system and storage (i.e. Hana), as well as other maintenance tasks.

In one embodiment, the system implements a request and response format, for example, extensible markup language (XML). XML requests can be dynamically formed. In another embodiment the system must have mandatory fields in the feedback panel 110, for example a product name, which can be used for functions such as filtering. These mandatory fields may be filled in by the user entering feedback information, or the mandatory fields may be populated by a computing device for ease, accuracy, or quickness.

Referring to FIG. 1, once the feedback information is received from the user, it may be transferred to a network 112 which contains a feedback server 113. The feedback server 113 can host or execute the feedback service 114, which can manage the feedback information and requests. The feedback information is then transferred over to a database 122 to store the information and make it accessible in near real time.

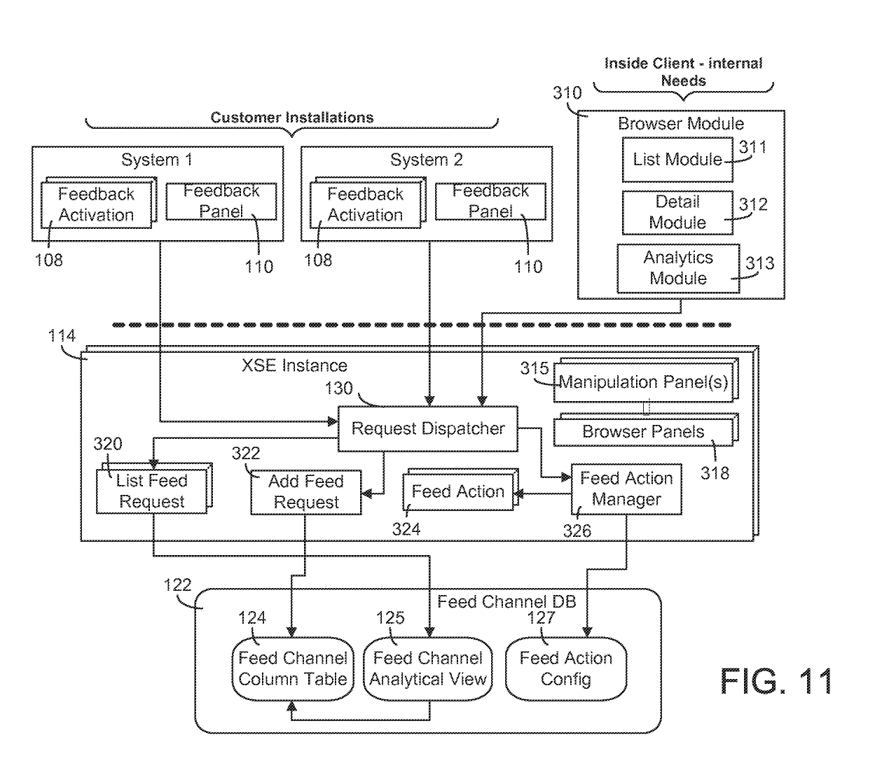

Access to the feedback service 114 can come from outside or within the network 112. In one embodiment, the feedback service 114 contains a request dispatcher 130 (FIG. 11), and access to the request dispatcher 130 can be from outside the network. In another embodiment, access to the feedback service 114 comes from within the network 112. There, internal needs can be met including using, manipulating, and changing the feed listing panel, feed details panel, and feed analytics panel.

In another embodiment, a customer uses the system and methods for needs of a product offered to users to use, and the customer provides feedback to the system for problems encountered while the customer and/or users are using the system and methods disclosed.

In one embodiment, a customer uses the system and methods for needs of a product of the customer's, the system and methods allow users of the customer's products to submit information including feedback, and the customer would like to access the feedback information from the system and use the feedback information.

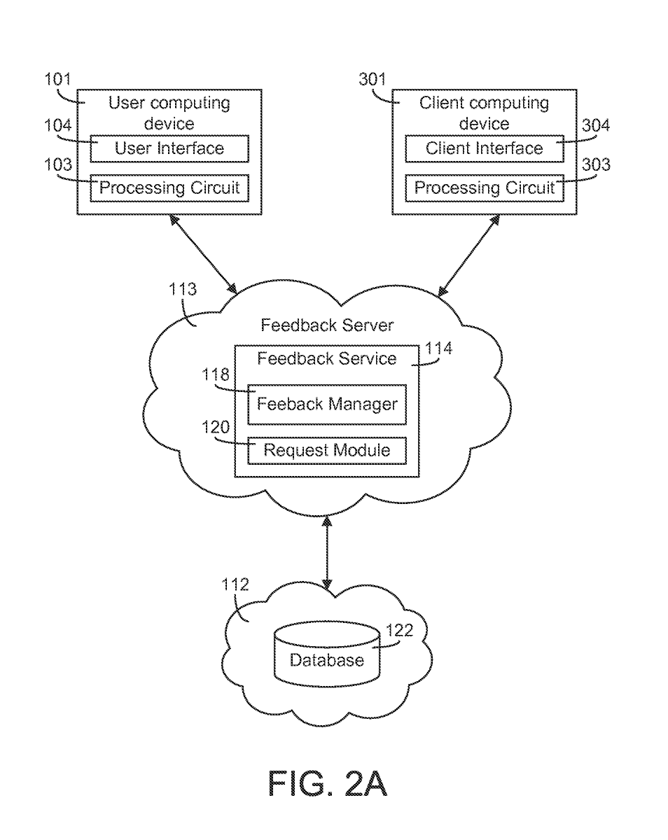

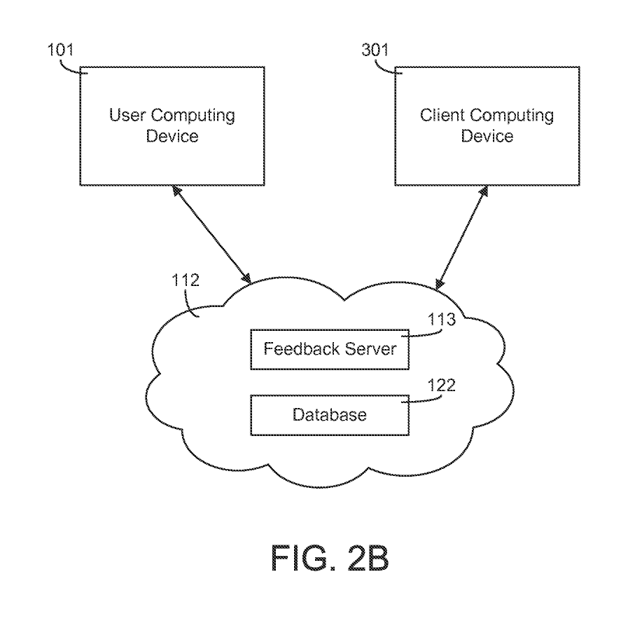

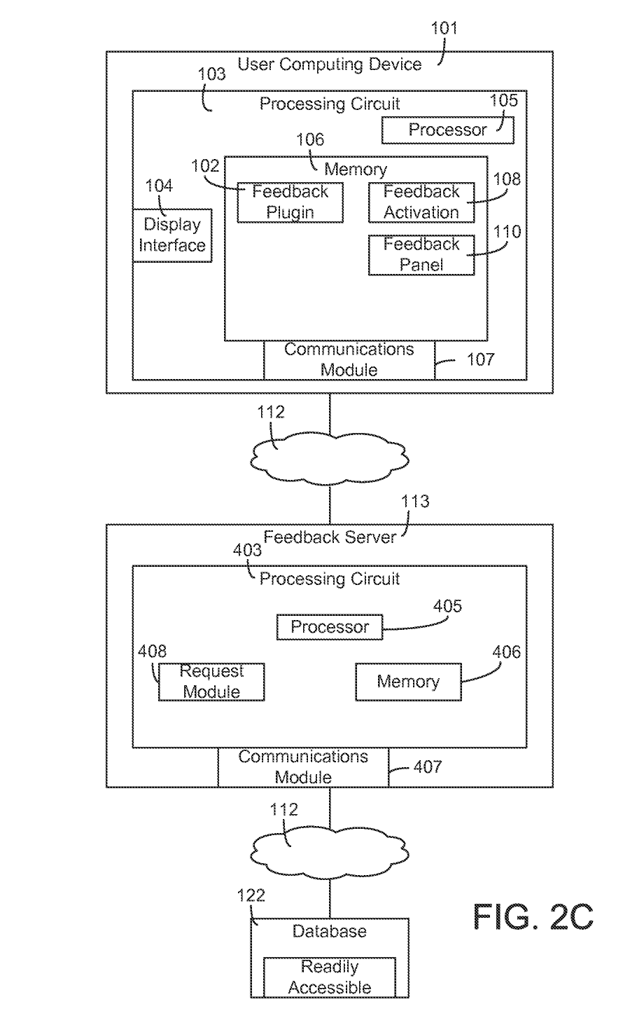

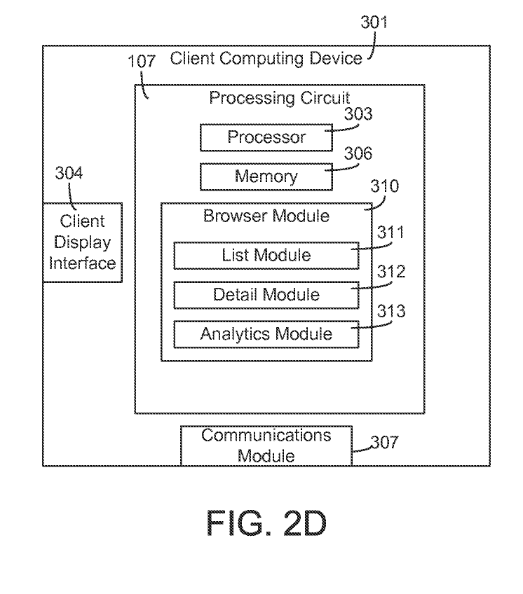

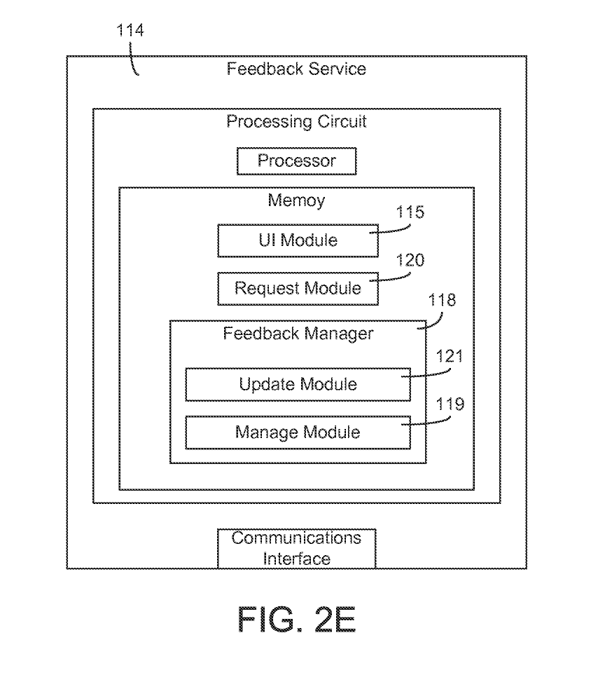

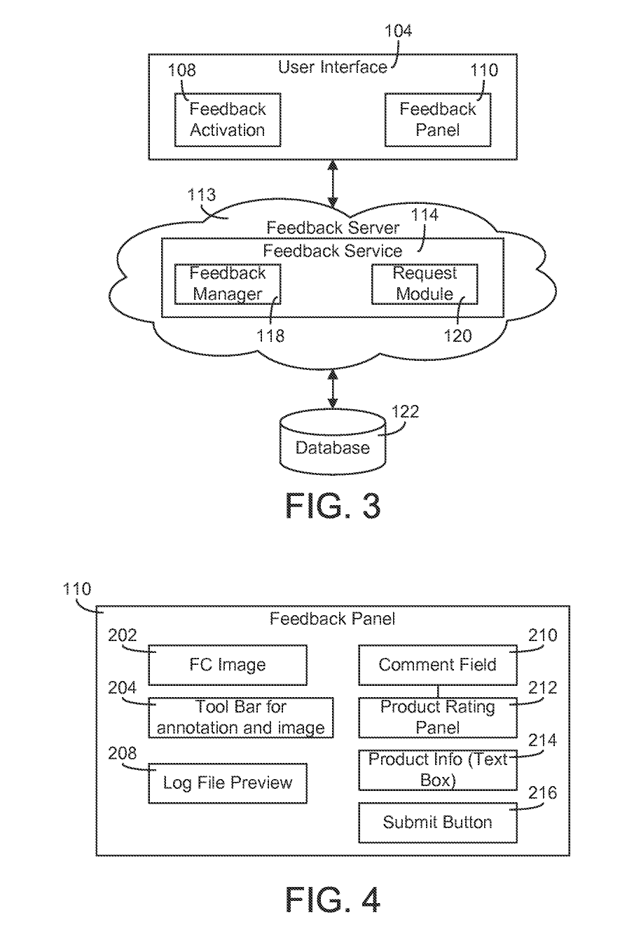

As shown in FIGS. 2A and 2B, the database 122 may be in the same network 112 as the feedback server 114 or on a different network. Both the feedback server 114 and the database 122 are stored on some network, including the internet or a network of servers, as to allow the real time update of information and continuous running of the systems to make the information immediately available. As shown in FIG. 3, the user computing device 101 may contain a feedback activation 108 and a feedback panel 110. The feedback activation 108 may serve as a channel or opening to initiate the process of giving feedback information. This feed activation 108 may be present in several rooms or spaces on the user display interface 104 within the user computing device 101. For example, this user feedback activation 108 can be a graphical icon or text button displayed on the user interface 104 display screen. The icon can be present in every room, relevant rooms, or highly utilized rooms. Upon engaging the icon or button, for example by clicking, the feedback panel 110 will be displayed.

The feedback panel 110 allows information, such as feedback or comments or images, to be submitted from a user to the feedback server 113. As displayed in FIG. 4, the feedback panel 110 can have a plurality of fields 202-216. Although the FIG. 4 shows eight fields, there can be more or less. In one embodiment, the fields can represent an image 202, a tool bar for annotation and image 204, a log file preview 208, a comment field 210, a product rating panel 212, a product info box text box 214 and a submit button 216. Feedback channel (FC) image 202 can be a screen shot of the page or some other image that a user would like to provide for feedback.

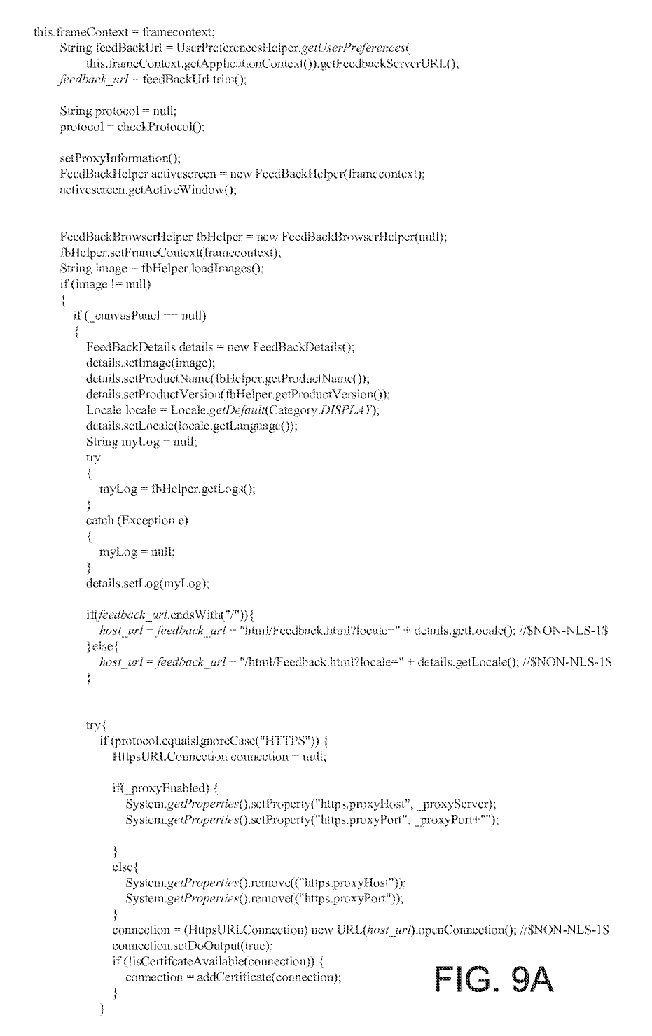

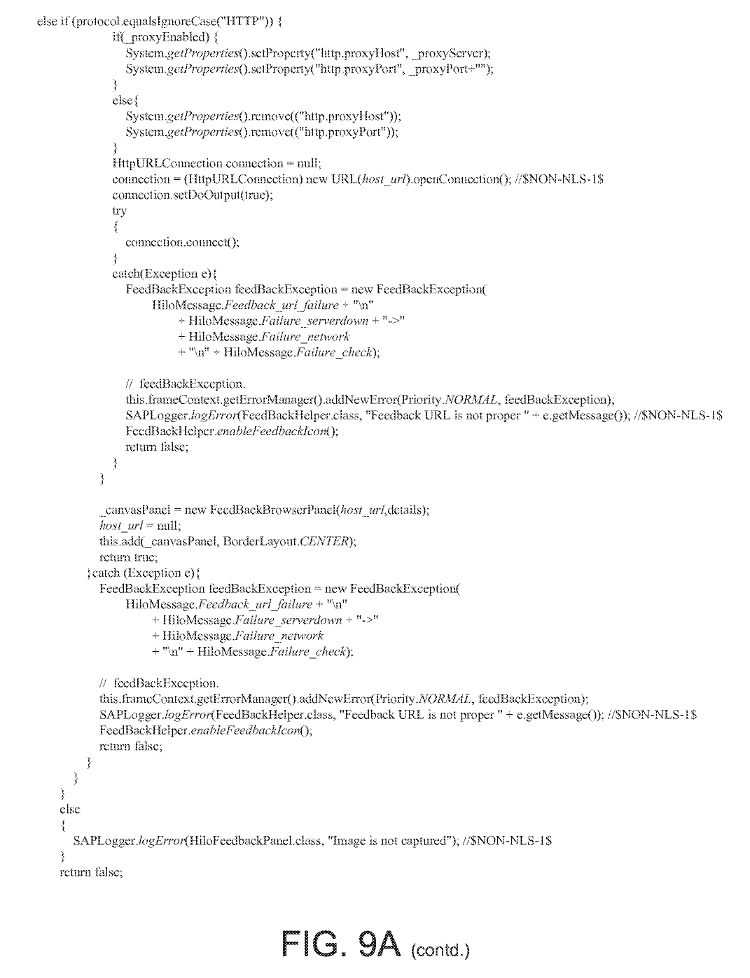

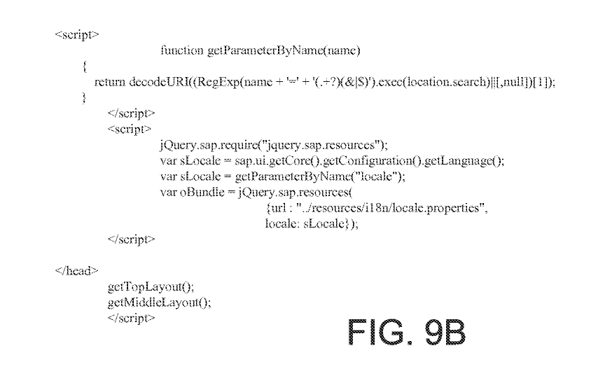

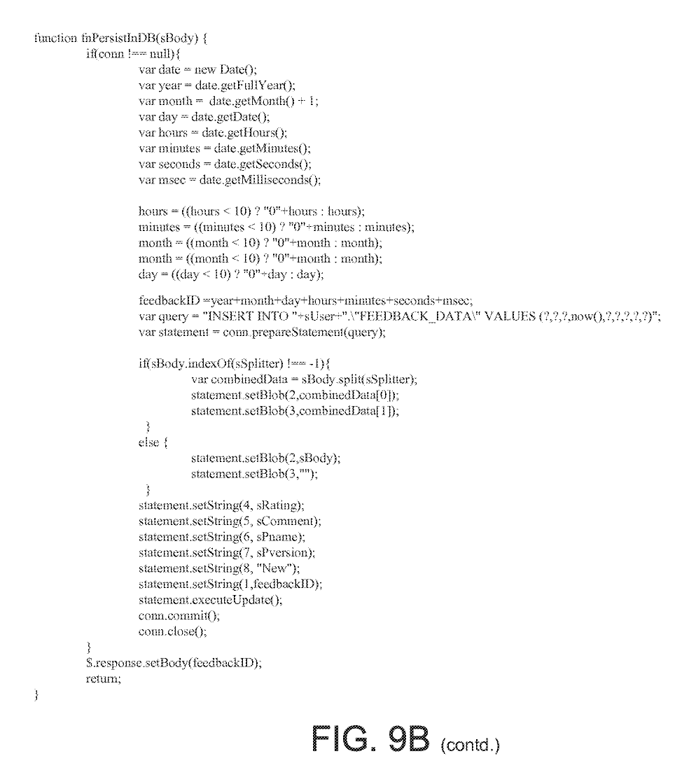

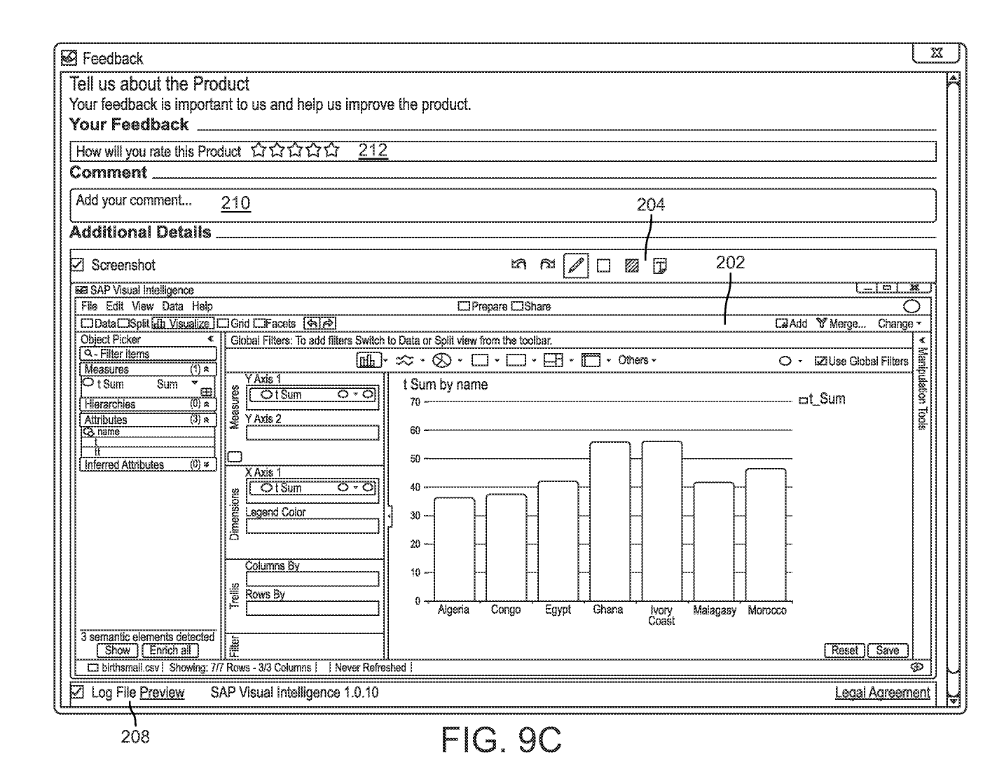

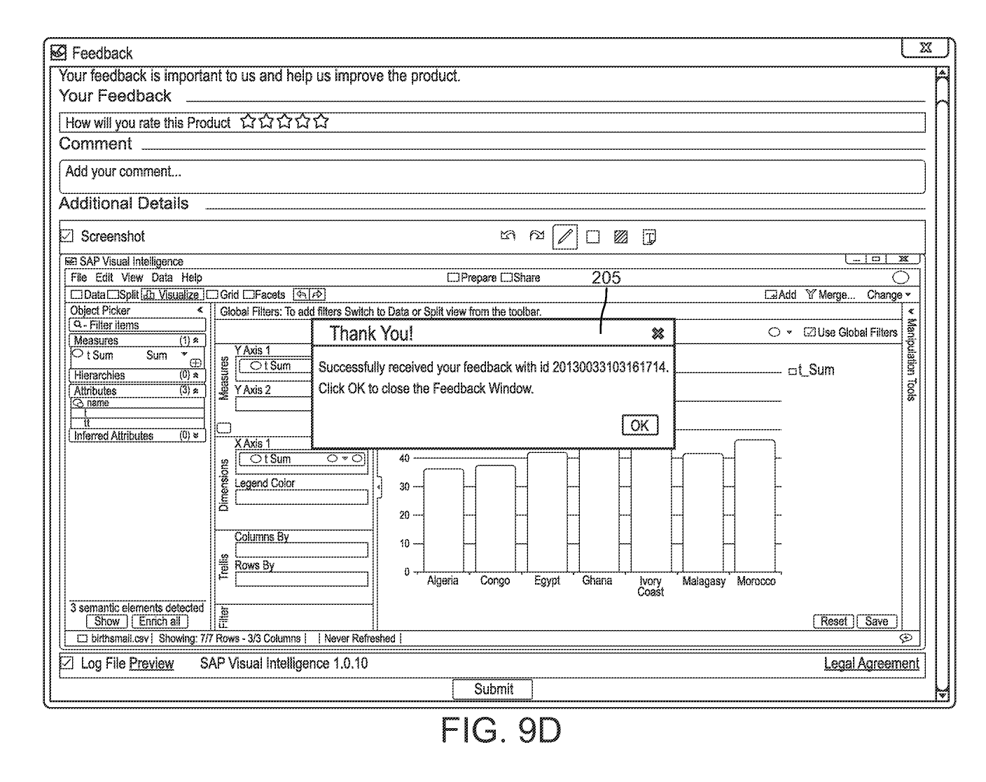

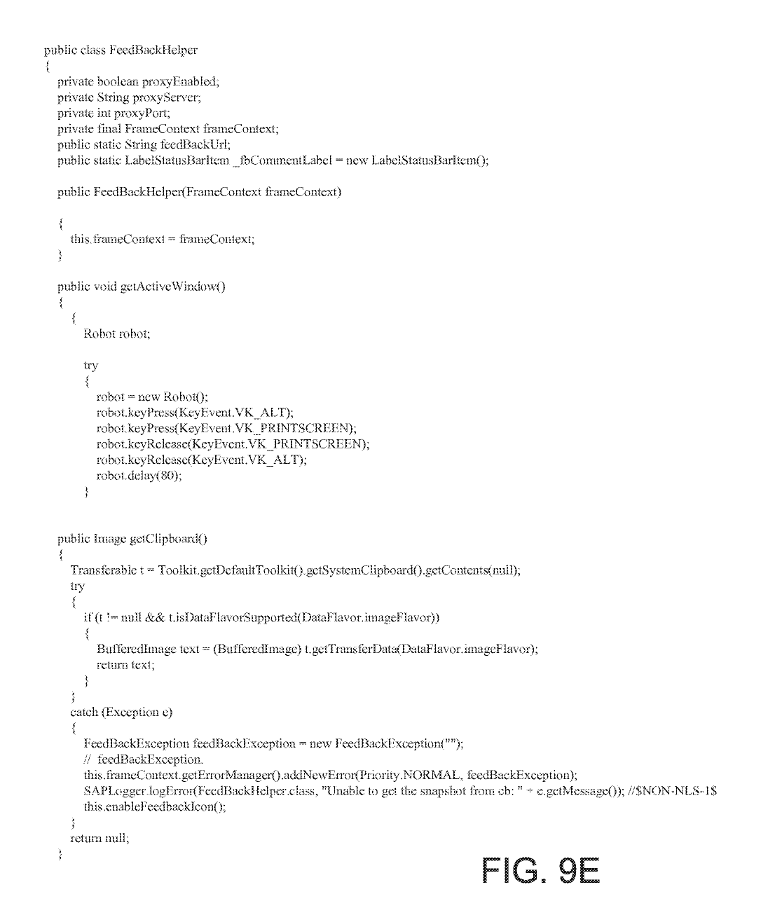

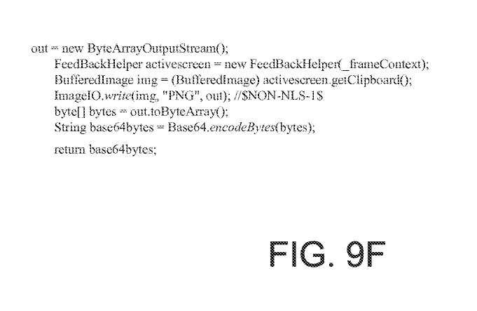

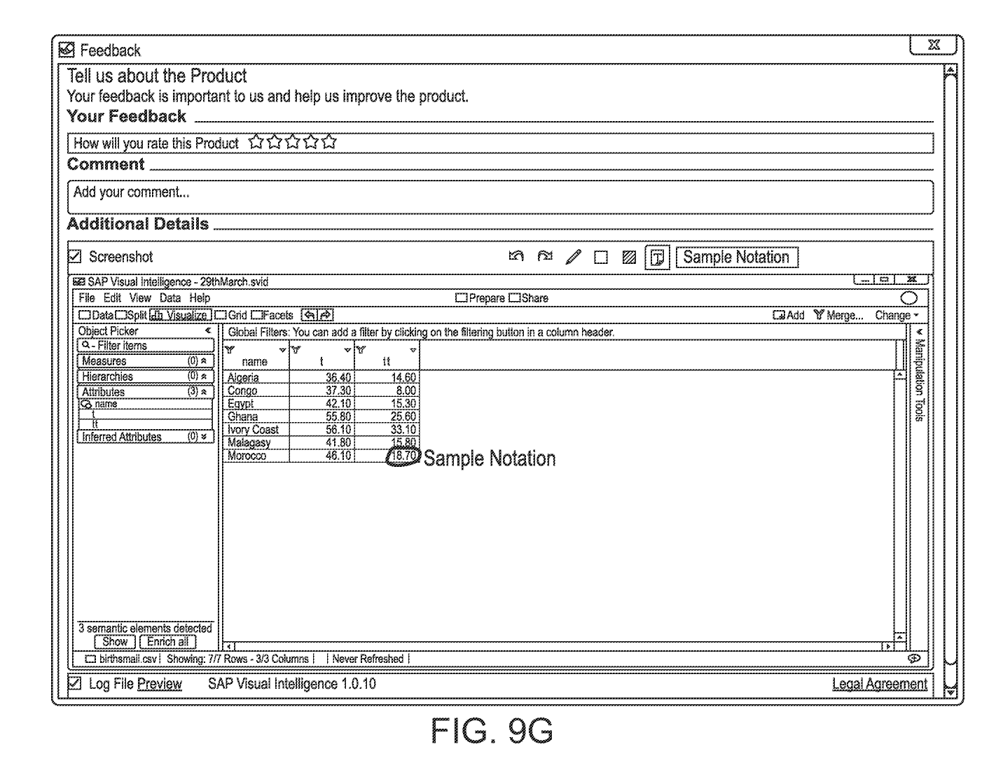

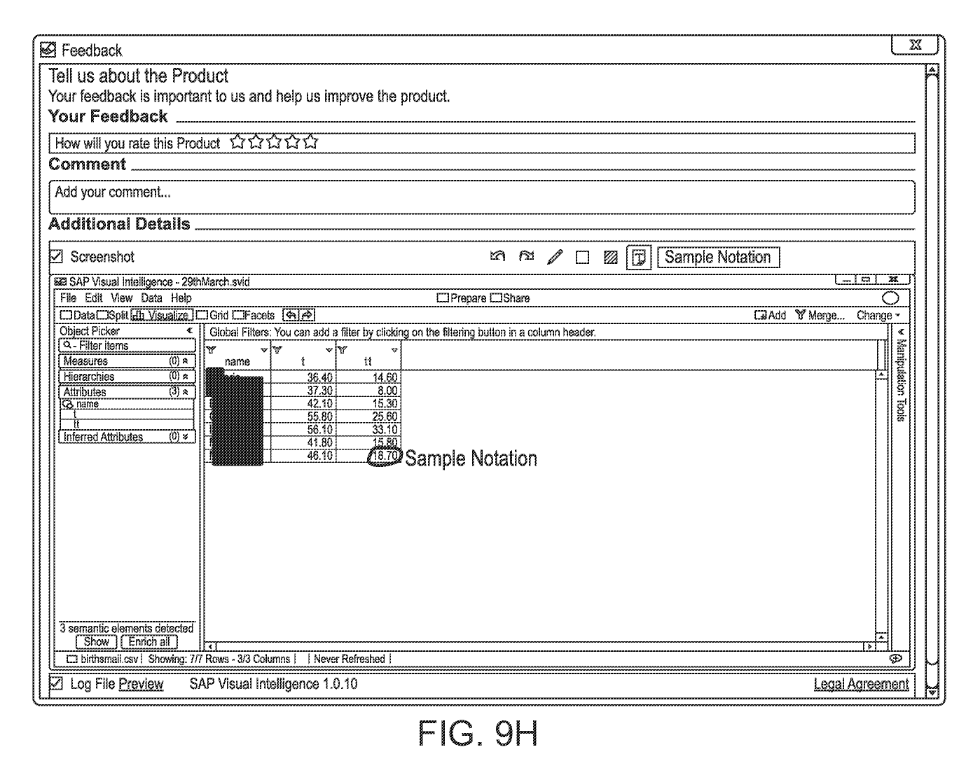

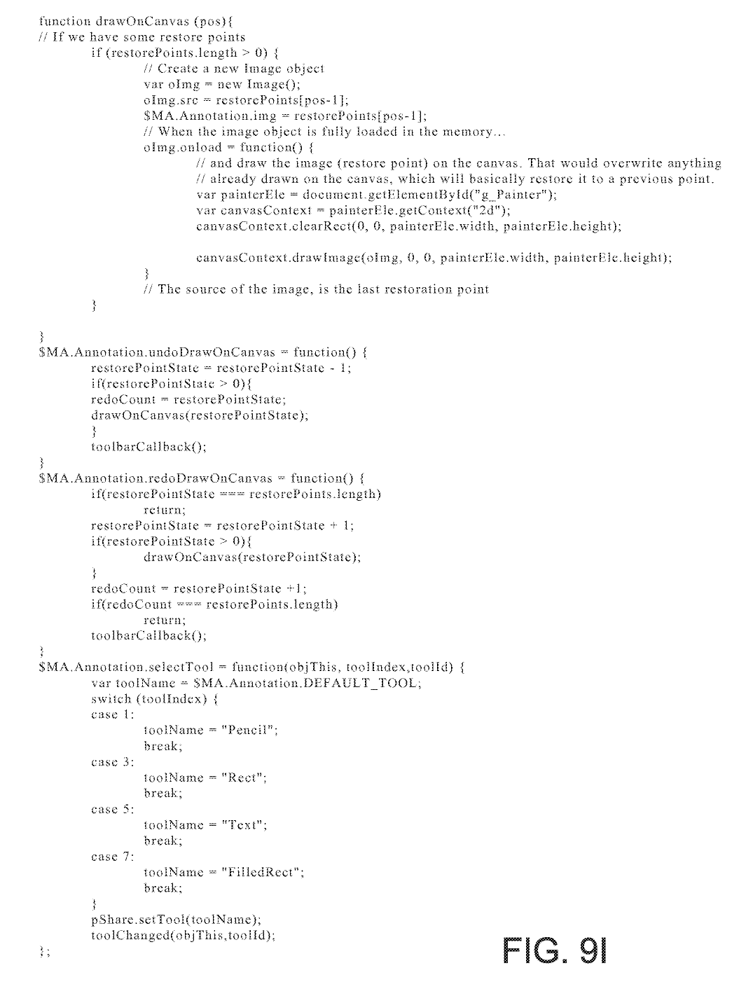

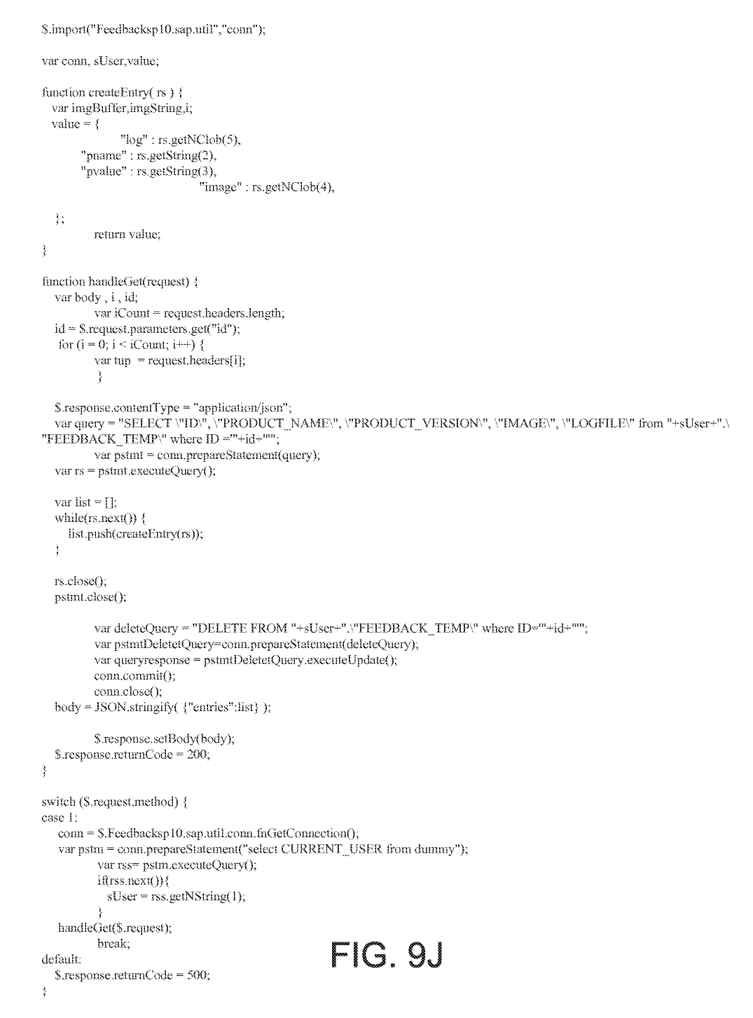

FIG. 9C exemplifies a screen shot of an image 202 being attached to the feedback panel 110 as shown through the user display interface 104. How an image 202 is taken and passed through the system 100 is further discussed below. A tool bar for annotation and image 204 allows images to be taken and edited, including writing notes on the screen, making markups (including but not limited to highlights, underlining, bolding, and italicizing), or blocking out portions of the image. This feature is useful when the user providing feedback wishes to point out or highlight certain information or would like to withhold sharing information which may be sensitive on the screen. Log file preview 208 allows the log file to be viewed prior to sending. Comment field 210 allows a user to enter a comment, whether by way of a short sentence or longer writing. Product rating panel 212 allows the user to rate the product on a scale provided by the feed panel. This rating could be numeric or by words.

Product info box 214 can be in the form of a text box and can allow the user to input information about the product in the field. This product info box 214 can serve as a parameter for storing the information in a database 122 to be retrieved easily. The user computing device 101 may also be configured to automatically populate the product info box 214. Submit button 216 can be used to submit the feedback information to the feedback server 113. FIG. 9D shows a screen shot of an image 205 that shows up on the user display interface 104 after the information has been submitted, letting the user know that the information was successfully received.

The feedback information from the feedback panel 110 can be submitted to the feedback server 113, and the feedback server 113, in one embodiment, could include a feedback service 114 with a request module 120 and feedback manager 118. The request module 120 receives and sends requests for the feedback server 113. The feedback manager 118 manages the feedback information including feedback that is received from the feedback panel 110 and also manages action requests for the feed. These management activities and action requests include a diverse amount of data manipulation and extraction activities currently known in the field.

FIG. 2C is a detailed block diagram of a system for receiving feedback information in near real time including a user computing device 101, feedback server 113, and storage 122 according to an exemplary embodiment. The following disclosure applies to all processing circuits disclosed, including the user computing device processing circuit 103 and feedback server processing circuit 403. Processing circuit (103, for example) may be a component of a collaboration service or another device that facilitates collaboration across reports. Processing circuit 103 includes a memory 106 and processor 105. Processor 105 may be, or may include, one or more microprocessors, application specific integrated circuits (ASICs), circuits containing one or more processing components, a group of distributed processing components, circuitry for supporting a microprocessor, or other hardware configured for processing.

According to an exemplary embodiment, processor 105 is configured to execute computer code stored in memory 106 to complete and facilitate the activities described herein. Memory 106 can be any volatile or non-volatile computer-readable storage medium capable of storing data or computer code relating to the activities described herein. For example, memory 106 is shown to include modules 102, 108, and 110 which are computer code modules (e.g., executable code, object code, source code, script code, machine code, etc.) configured for execution by processor 105.

According to some embodiments, processing circuit 103 may represent a collection of processing devices (e.g., servers, data centers, etc.). In such cases, processor 105 represents the collective processors of the devices and memory 106 represents the collective storage devices of the devices. When executed by processor 105, processing circuit 103 is configured to complete the activities described herein. Processing circuit 103 includes hardware circuitry for supporting the execution of the computer code of modules contained within. For example, processing circuit 103 is shown to include communications module 107. Communication module 107 may include hardware to receive data from a network or serial BUS and to communicate data to another processing circuit via a network or serial BUS. Communication module 107 may be configured to receive or transmit data wirelessly (e.g., via radio signals, via infrared signals, etc.) or over a hardwired connection (e.g., a CAT5 cable, a fiber optic cable, etc.).

FIG. 2D is a detailed block diagram of a client computing device 301 used in retrieving and accessing feedback in real time according to one exemplary embodiment. This shows browser module 310 used to make action requests, with list module 311, detail module 312, and analytics module 313 used to request specific actions and display the results. A client can solicit a list of the feedback information using list module 311. A client can use detail module 312 to view certain details and specifics about the feedback information the client would like to request or the returned feedback information. Analytics module 313 executes code required to perform and view analysis of the feedback information.

FIG. 2E is a detailed block diagram of a feedback service 114 used in the system described according to one exemplary embodiment. The feedback service 114, in one embodiment, contains a user interface (UI) module 115 used to propagate rich html interface pages to be displayed on the client computing device. For example, rich html pages can be configured to be displayed on the client display interface 304 or through the browser module 310 of the client computing device 301. The feedback service 114 includes a feedback manager 118 including an update module 121 and manage module 119.

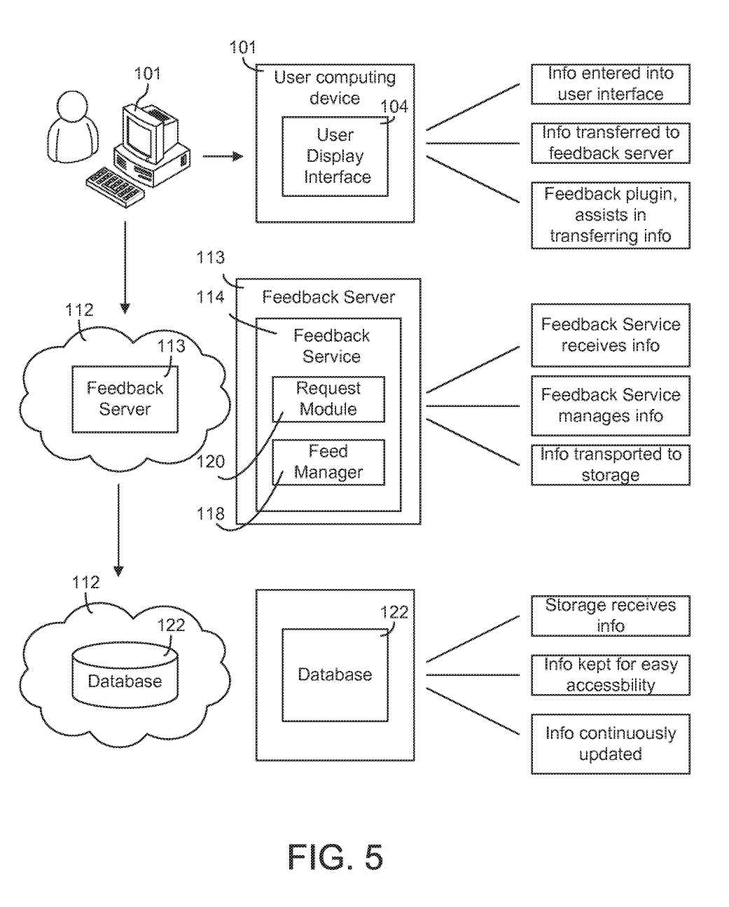

Referring to FIG. 5, a detailed flow chart and block diagram of the process from the front end according to an exemplary embodiment is shown. Feedback information is entered into the user display interface 104 and transferred to the client server 113. A general plugin 102, in this case a uniform resource locator (URL), is used to assist in transferring the feedback information. The client application 114 executed by the client server 113 receives the feedback information in real time and also manages the feedback information in real time. The feedback information is then transferred to database 122. The database 122 receives the feedback information and keeps the feedback information for real time access. The information in the database 122 is also continuously updated in near real time.

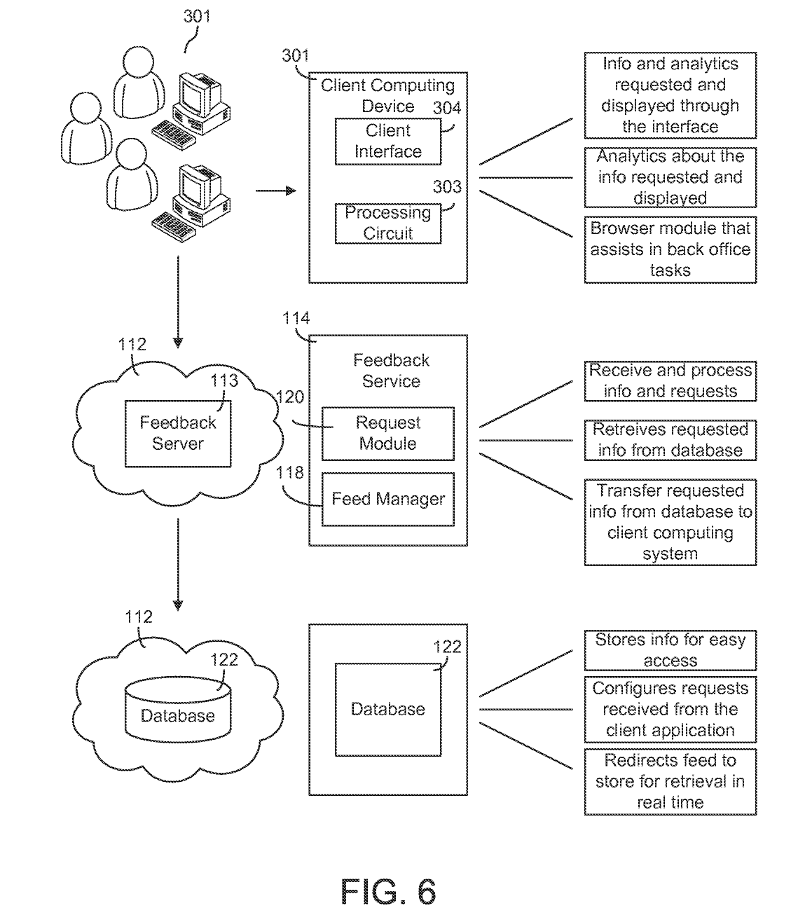

As shown in FIG. 6, a detailed flow chart and block diagram of an embodiment of the process from the back end is shown. Using a client computing device 301, a client makes a request for feedback information and/or analytics through the client display interface 304. The requested information will be shown on the client display interface 304 once the process completes. The client display interface 304 contains a browser module that assists in back office tasks, for example requesting and reviewing analytics and statistics gained from the system to troubleshoot a problem or get the position of a product on the market. The feedback service 114 receives the request and, through request module 120, processes the information from the database 122. The request module 120 communicates with the feedback manager 118 and the database 122, and the requested information is retrieved from the database 122. The request module 120 then assists in transferring the requested information from the database 122 to the client computing system 301 to be displayed on the client display interface 304. The storage 122 stores the information for easy access and is configured to receive and fulfill requests from the client application 114. The database 122 redirects feedback information that comes into the database to be stored in a manner in which the information can be retrieved quickly in real time. The feedback information that can be requested and retrieved may include very thorough and detailed parameters.

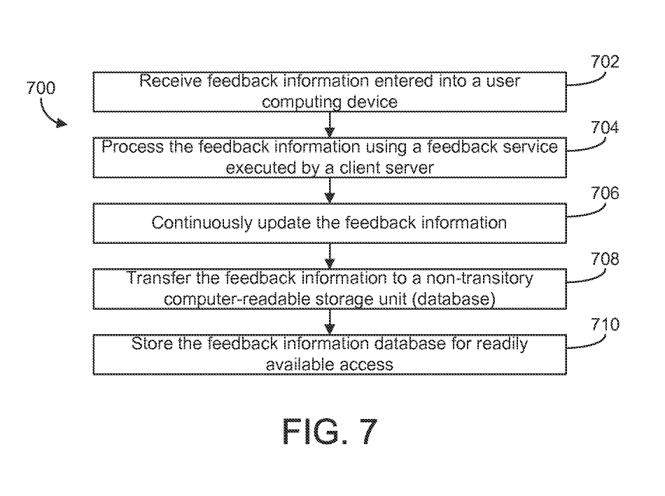

FIG. 7 is a flow chart of a process 700 of receiving feedback information in real time and storing for access in real time according to an exemplary embodiment. The steps involve receiving feedback information entered into a user computing device 101 (step 702) having a processing circuit 103 configured to receive feedback information from a plurality of users. The user computing device 101 also includes a user display interface 104 configured to display feedback information and a feedback architecture 102 configured to enable feedback information to be provided in real time. The process 700 also involves processing the feedback information using a feedback service 114 executed by a feedback server 113 (step 704) wherein both the feedback server 113 and the feedback service 114 are configured to operate in near real time. The process 700 also includes continuously updating the feedback information in real time (step 706). The process 700 involves transferring the feedback information to a non-transitory computer-readable storage unit (database 122) (step 708), which stores the feedback information and provides access to the feedback information in real time (step 710).

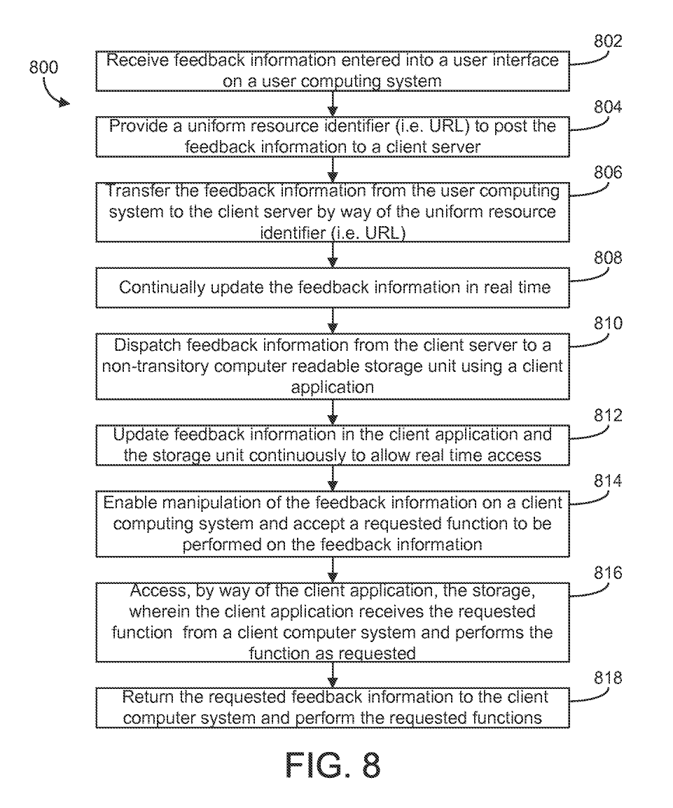

FIG. 8 is a flow chart of the process 800 of using the feedback system for back office purpose according to an exemplary embodiment. The process 800 involves receiving feedback information entered into a user display interface 104 on a user computing device 101 (step 802), providing a uniform resource identifier (i.e. uniform resource locator) to post the feedback information to a feedback server (step 804), and transferring the feedback information from the user computing device 101 to the feedback server 113 by way of the uniform resource identifier (step 806). The feedback server 113 is continually updating the feedback information. The process also involves dispatching feedback information from the feedback server 113 to a non-transitory computer readable storage 122 unit using a feedback service 114 (step 810), wherein the non-transitory computer readable storage unit 122 is located on a network of servers and continuously runs to keep feedback information updated in real time (step 808).

Feedback information in FIG. 8 is updated in the feedback service 114 and the non-transitory computer readable storage 122 continuously to allow real time access to the feedback information (step 812). The process 800 further includes using a system in a back office capacity by enabling manipulation of the feedback information displayed on a client computing system 301 and accepting a requested function to be performed on the feedback information (step 814). One can then access, by way of the feedback server 113, the non-transitory computer readable storage 122, wherein the feedback server 113 receives the requested function (i.e. action request) from a client computing device 301 and performs the function as requested (step 816). The process 800 also includes returning the requested feedback information to the client computing device 301 and performing the requested functions (step 818).

In one embodiment, a URL is used to facilitate the feedback plugin 102 in integrating the feedback architecture of the system. FIG. 9A is a schematic view of a code sample of the feedback plugin of the system according to an exemplary embodiment. A string feedback URL is set as the user preference and appears in the active window. The feedback browser is then set to load images along with a variety of details as shown. The system then sets the host URL as the connection, and uses an open connection operator to set the output through the connection. The feedback icon is enabled and connected to the URL connection.

In FIG. 9A, an application such as Visual Intelligence can use the feedback architecture just by using the URL Connection.connect( ) code and other details and parameters needed can be passed into this URL through requests such as XML. This architecture can be used with any technological platform and allows the feedback to be entered from any user and received by any server. At the back end, this framework can keep the information in the database for further processing.

FIG. 9B shows a schematic view of a code sample at the back end of the system according to an exemplary embodiment. A function is set by the name of a parameter, the URL is decoded, and a search of a location is executed by the system. At the back end, data is configured to persist in the database by various parameters including the date and time. Various queries may be run on the data, such as insert into, and the system may be requested to prepare and return a statement. The system sets the body of the response and saves it to identify the feedback and return it to the client interface for viewing.

In one embodiment an image can be taken to include in the feedback panel 110. A user may want to pass the feedback information or error to someone through a screen shot so that immediate attention can be brought to the party responsible for addressing the issue. FIG. 9E shows a sample of code used to allow an image to be taken with the application. For example, any Java client may utilize the framework shown in FIG. 9E, which is implemented and used to ensure generation of an OS event of print screen and then rendering. The framework described involves setting a frame context using a static URL string, engaging the robot key press and release functions to catch a print of the screen, and obtaining a public image using the clipboard. The process then involves using the system clipboard to get the contents of the print screen, grabbing a buffered image, and enabling the feedback icon to attach the image.

In one embodiment, the entire feedback framework is in java script so that it is pluggable with any client of any technology. To integrate, the system can be set to pass the image information to java client, which is hosted on Java FX. The image can be passed as a buffer by converting the image to a buffer string and in the java script/feedback framework, converting it back to string. FIG. 9F shows an exemplary sample code of how the image can be passed to the application.

FIGS. 9G and 9H display screen shots of an image with annotations and further blocking of information for view according to an embodiment of the invention. This allows a user to add information that may be helpful on the back office end, and it allows a user to block out certain parts of the screen. FIG. 9I describes a sample of the code used to allow annotation on the figures. This code executes drawing on the canvas and creates a new image object with the annotations. When the image object is fully loaded in the memory, a function to load the image can be used to draw a new image which would overwrite anything already drawn on the canvas. This essentially restores the image to a previous point. Several restorations of different parameters can be executed accordingly, and the annotation can be attached to the image through the redo draw on canvas function. The code is also set to allow annotations to be made with different selected tools, including pencil, rectangle, text break, and filled rectangle.

In an embodiment, the server and the back office application operates in near real time. The feedback framework including the feedback server 113 and feedback service 114 operates such that the information is not static. The back office application is also up and always running. In one embodiment, a feedback application is created on HANA as a XS Engine application. The HANA server hosts the feedback office application and is in a public cloud where anyone can access at any time. In this embodiment, both the XS Engine application and HANA server is in real time, and issues and concerns of a user is easily addressed without delay.

FIG. 9J shows an example of code used to implement non-static information in the system. A function is used to create an entry, and a function is used to handle getting requests. The request may identify certain parameters to retrieve. A response will then be created in the application based on the content type of the request. Certain values may be entered in the query to solicit the response, including but not limited to selecting the identification, product name, product version, image, log file, etc. The query directs the system to retrieve the data from the feedback temporary space. The system then prepares a query statement and executes the query. When the statement is closed, another query is created to delete the feedback from the user's temporary space that was previously identified. A connection statement is prepared to delete the query, and the response to the query is configured to execute an update in response to deleting the query. Request methods may also be switched. In an example case shown in FIG. 9J, the feedback information is configured to be posted through a URL using a get connection function. A statement is prepared for the current user, and a search query is executed to return a request.

In another embodiment, the system can support the voice of a user and can capture the emotions of a user while capturing the feedback. While the user gives the feedback, the user can turn on the voice enabled feature and can speak into the system as if the user is speaking with support personnel. The recorded voice is decoded and kept in the database 122, then the decoded voice is later converted back. In this respect, the emotions of the customer may also be captured while the user is giving feedback and stored. One issue with textual feedback is that one word can have several meanings. Emotions behind the words can be important to capture as well. The voice support of the system also allows the user to talk to give feedback instead of writing, which may take up more of their time.

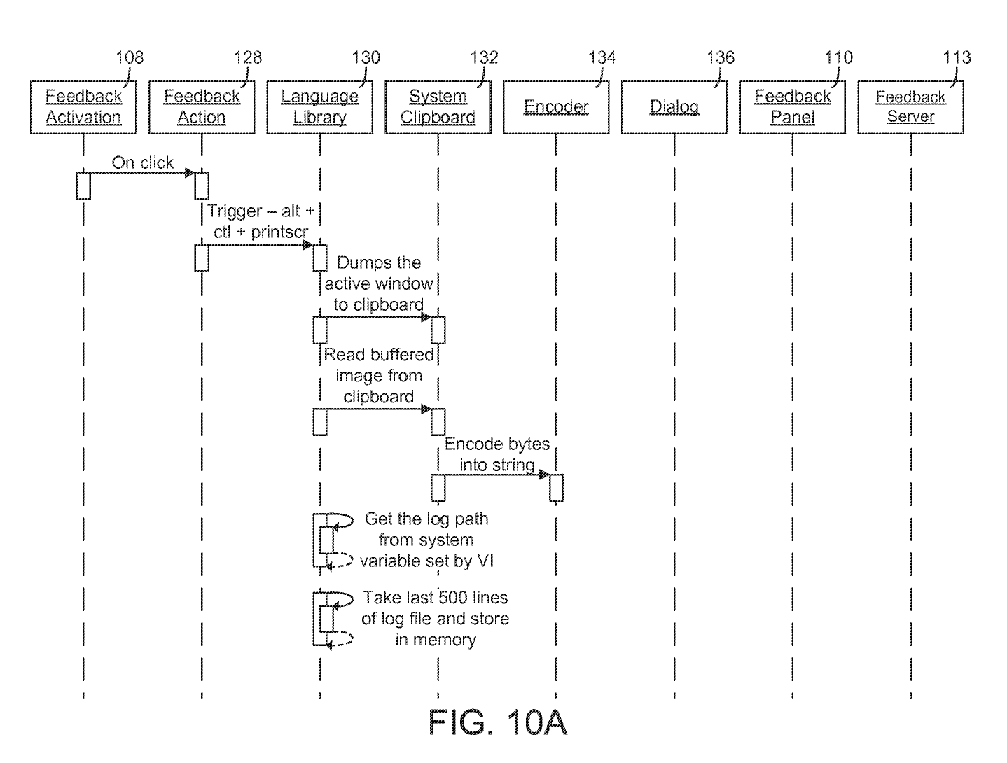

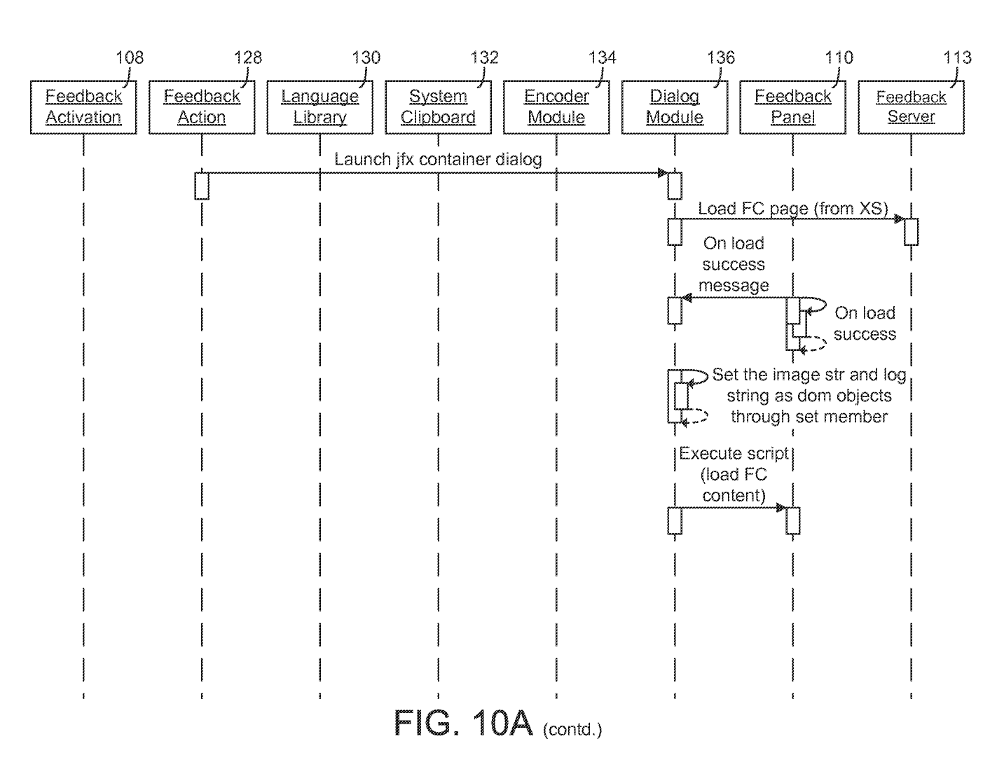

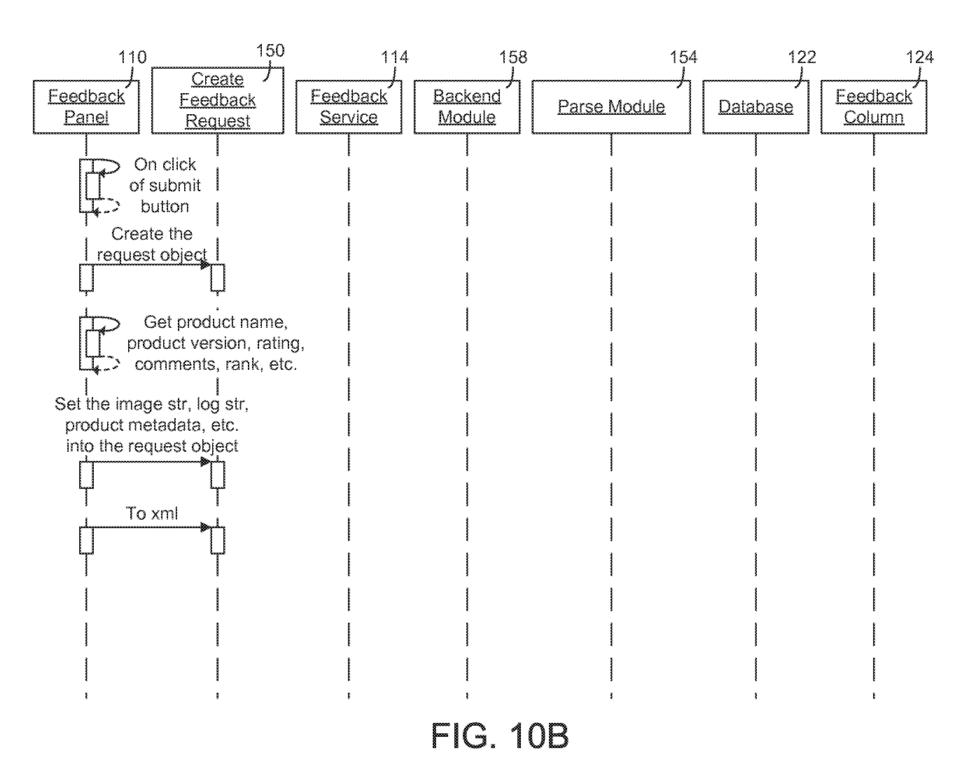

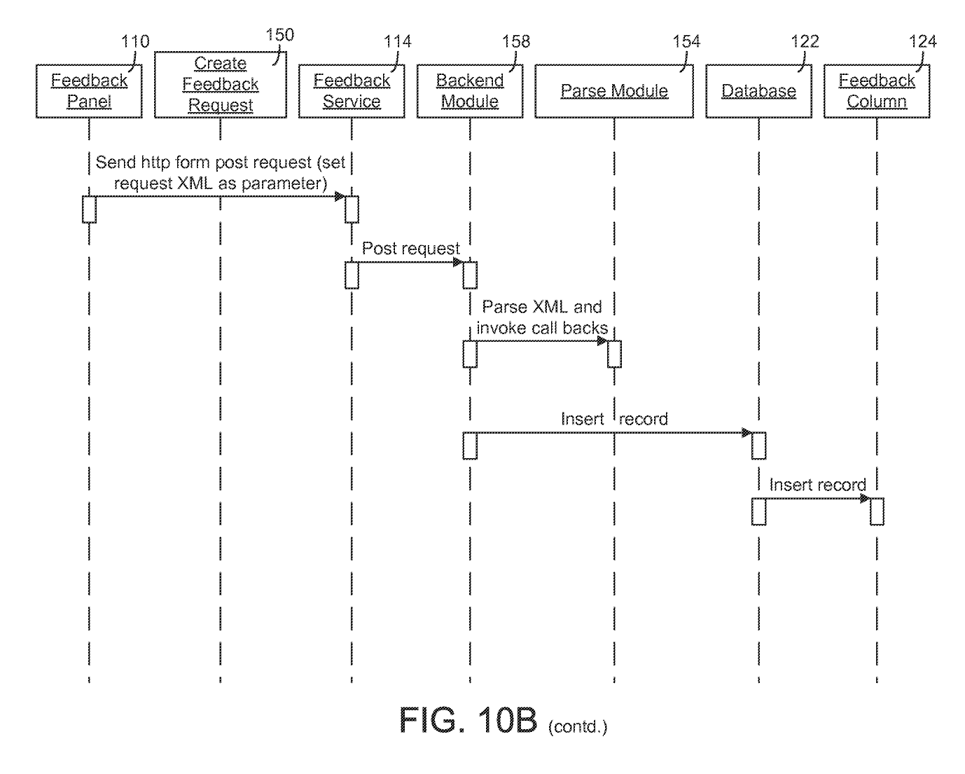

Referring to FIG. 10A, the steps of launching the feed information on the client server is shown according to an exemplary embodiment. Upon clicking the feedback activation 108, the feedback action panel 128 arises. This action triggers a print-screen function that maps according to a language library 130 of a system, for example Robot API. The active window is dumped to the system clipboard 132 of the computing system, and a clipboard object awt on Java for example is used to copy and paste objects between different instances of the application. The buffered image is read from the system clipboard 132 and bytes are encoded into string using an encoder 134. The robot language library 130 gets the log path from the system variables set by the user computing system 101. The robot language library 130 then takes the last 500 lines of log file and stores it in the memory. Through this process, the application container dialog is launched on the Java dialog module system 136, which hosts the application webview. The feedback page is loaded from the feedback server 113, for example Hana XS Engine (https). On the load success message, the Java Dialog 136 and feed panel, the string images are set and the log string is set as the dominant objects through set members. The Java dialog 136 executes the script and loads the feedback content onto the feedback panel 110.

Referring to FIG. 10B, the system describes steps of posting the feed information to the back end of the application. The system creates a request object when the submit button of the feedback panel 110 is clicked. The system then gets information entered into the feedback panel 110, such as the product name, version, rating, comments, rank, etc. and sends the information to XML, where the log and image is encoded as cdata sections. The system sets the image string, log string, product metadata, etc. into the request object. The system then sends http form post requests to the feedback service 114 for example Hana XS, setting the request XML as a parameter. The feedback service 114 posts the request to the backend module 158, which parses XML and invokes call backs to the memory xml parse module 154, and inserts the record from the feedback end of an engine, for example .xsjs of Hana, into the database 122. The record is further inserted into a feed column table in the database that stores the data in columns for easy access and retrieval. The feed column table 124 scheme includes but is not limited to ID (identify), Image (blob), Log(blob), comment (varcher), rating (integer), product name (varchar), product version (varchar), and status (varchar), new and viewed.

FIG. 11 is a view of a high level design of the system according to an exemplary embodiment. In one embodiment, the feedback activation 108 on a user computing system is presented in multiple rooms in a system and multiple places. The feedback panel 110 is based on JFX Panel and allows users to edit, print screen pictures, add text, and annotate on the picture, select from a pre-existing list of feedback, or more. Access to the request dispatcher 130 in the engine is from outside the network. Another feedback panel 110 on the front or back end could provide a new area for feedback manipulation that also includes options to edit, print screen pictures, add text, and annotate on the picture, select from a pre-existing list of feedback, or more. The system sends an XML request over https to the request dispatcher 130, and the load balance https allows access to the feedback service XSE 114. The request dispatcher 130, which receives and transfers requests, handles requests for the system including listing feed requests, adding the feed request and connecting with the feed action manager as the application performs the feed action. In the feedback service 114, manipulation panels 315 and feed browser panels 318 appear as Rich SAP UI5 based html pages which are loaded onto the browser module 310 of the client side. The feedback action manager 326 finds mapped feedback actions 324 and transfers the feedback action 324 to the database 122 for feedback action configuration 127. The feed database also has channels for several views including a column table 124 and an analytical view 125. The analytical view 125 can be redirected into the column table 124.

Also in FIG. 11, for client internal needs, the client may have a browser module 310 on the client display interface. The browser module 310 includes a list module 311 for listing the feedback information, a details module 312 for recalling and entering specifics about the feedback information, and an analytics module 313 for analyzing the feedback information. The modules on the browser module 310 includes capabilities such as getting a list of data, getting details behind the data, and listing aspects such as a title and detailed summary. Analytics that may be performed includes but is not limited to numerical calculations and a summary or analysis of the feedback such as mean, average, standard deviation, percentages, comparison, likelihood, and cost projections.

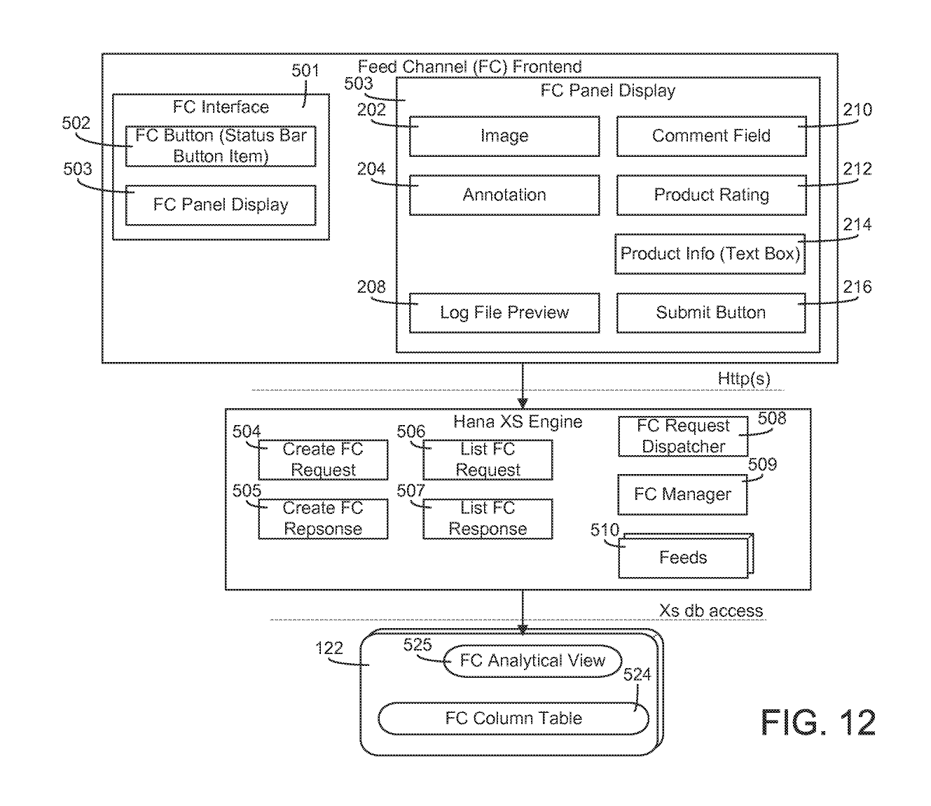

FIG. 12 is a detailed view of the design of the components in the system. In one embodiment, the front end of the system from a user's system includes a FC (feedback creation) interface 501 that includes a feedback creation button or a status bar button 502 and a feedback creation panel display 503. The feedback creation panel display 503 shows similar features as recited above, wherein the pages are displayed in html/SAP UI 5. The feedback service 114 Hana XS Engine receives the feedback through XML request and response over http(s). Hana XS Engine allows the creation and listing of feed requests and response on a plurality of modules (504-507), and the feedback request dispatcher 508 assists in coordinating the requests. The feedback manager 509 manages the feedback, and the feedback information is duplicated as necessary in the application (510). The feedback service has access to the database 122, and interacts with the database 122 to send and retrieve information. Also, the feedback information transfers back and forth between the feedback service and the column table and analytical view of the database 122. The database 122 loads HANA instances.

The present disclosure is relevant is several situations. For example, a solution manager of an enterprise who encounters a bug or an issue in a product, such as SAP Visual Intelligence could use an embodiment of the present disclosure to provide feedback without wasting time. Also, a user can use the present disclosure to provide feedback for all products without having to reach another entity or take extra actions. The disclosed embodiments may also be used to accept feedback in a variety of avenues, including screen shot images, annotated images, video, text, or voice. An embodiment of the present disclosure may also allow a user to compare feedback information gathered from a plurality of products, allowing additional value in analyzing the feedback information.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish various connection steps, processing steps, comparison steps and decision steps.

What is claimed is:

1. A computerized method for receiving and managing user feedback regarding a software application, comprising:
at the software application, receiving a request from a user to provide feedback regarding the software application;
getting information regarding a state of the software application;
using a remote address to obtain feedback panel resources;
presenting a graphical feedback panel using the obtained feedback panel resources;
forming and transmitting a standardized web communication request having embedded feedback information comprising a plurality of parameters and wherein at least one of the parameters comprises a markup language tree, wherein the plurality of parameters comprises feedback panel input and the state of the software application;
at the feedback server, which exposes a server interface to the standardized web communication request, identifying the parameters of the standardized web communication request; and
at the feedback server, using the identified parameters and the markup language tree to insert a feedback record into a database.

2. The method of claim 1, wherein the software application is a compiled computer application, and wherein separate feedback panel content is not precoded for each application feature.

3. The method of claim 1, wherein the feedback panel resources comprise a script for building the markup language tree using the feedback panel input and the state of the software application.

4. The method of claim 1, wherein the feedback panel resources comprise a web page, and wherein the information retrieved regarding a state of a software application is retrieved using information not accessible to a web browser or web script and wherein the feedback panel converts the information to string information and sets the string information as a web document object of the web page.

5. The method of claim 1, wherein the information retrieved regarding the state of the software application is a screen shot.

6. The method of claim 5, wherein getting information regarding a state of the application comprises: using compiled code local to the software application to cause a print screen command to be executed and for the print screen output to be sent to the system clipboard, using the compiled code to access the system clipboard and to save the system clipboard to a buffer, using the compiled code to convert the buffer to a byte array, and converting the byte array to a string.

7. The method of claim 6, wherein the graphical feedback panel comprises a tool for graphically editing the print screen content prior to being sent to the clipboard.

8. The method of claim 7, wherein the tool for graphically editing comprises at least one of a blur tool and an annotation tool.

9. The method of claim 1, wherein the feedback server comprises an application running in an execution environment tightly coupled to a database server.

10. The method of claim 1, wherein the feedback panel comprises a tool for recording voice feedback.

11. The method of claim 10, wherein the software application uses compiled code to record the voice feedback and to convert the voice feedback to a string for providing with the standardized web communication request.

12. A system for receiving user feedback, comprising:
a feedback server coupled to a database and comprising a service for forming a feedback channel by exposing a server interface to a standardized web communication request having embedded feedback information, wherein the embedded feedback information comprises a plurality of parameters and wherein at least one of the parameters comprises a markup language tree; and
a user computer running a software application having a user control for initializing the feedback channel, wherein the user computer is configured to receive feedback resources and logic not compiled with the software application via the feedback channel;
wherein the feedback server is configured to identify the parameters of the standardized web communication request, and to use the identified parameters and the markup language tree to insert a feedback record into the database.

13. The system of claim 12, wherein the feedback server forms the feedback channel without first serving a web page defining each of the feedback fields.

14. The system of claim 13, wherein the feedback resources comprise a web page, wherein the software application of the user computer collects system information not accessible to a web browser or web script and converts the collected system information to string information and sets the string information as a web document object of the web page.

15. The system of claim 14, wherein the web page comprises a script that converts the web document object and the other feedback information to the markup language tree.

16. A computerized method for receiving and managing user feedback from multiple separate user sources, comprising:
at a feedback server, without first serving a web page defining each of the feedback fields, forming a feedback channel by exposing a server interface to a standardized web communication request having embedded feedback information, wherein the embedded feedback information comprises a plurality of parameters and wherein at least one of the parameters comprises a markup language tree;
at the feedback server, identifying the parameters of the standardized web communication request; and
at the feedback server, using the identified parameters and the markup language tree to insert a feedback record into a database.

17. The computerized method of claim 16, wherein the feedback server is configured to receive feedback from a plurality of application states using the same feedback channel.

18. The computerized method of claim 17, wherein the feedback server is configured to receive screenshot data as string information stored within the markup language tree.

19. The computerized method of claim 16, wherein the standardized web communication request is an HTTP POST request.

20. The computerized method of claim 19, wherein the markup language tree is an XML set.
